(19) United States
(12) Patent Application Publication
(10) Pub. No.: US 2006/0117644 A1
(43) Pub. Date: Jun. 8, 2006

(54) Bait box

(76) Inventors: Paul Hoyes, Lincolnshire (GB); Nigel Peter Binns, Derby (GB)

Correspondence Address: MADSON & AUSTIN;GATEWAY TOWER WEST, SUITE 900, 15 WEST SOUTH TEMPLE, SALT LAKE CITY, UT, 84101, US

(21) Appl. No.: 10/532,539

(22) PCT Filed: Oct. 31, 2003
(86) PCT No.: PCT/GB03/04717

§ 371 Date: Aug. 30, 2005

(30) Foreign Application Priority Data
Nov. 1, 2002 (GB) 0225485.2

(51) Int. Cl. A01M 25/00

(52) U.S. Cl. 43/131

(57) ABSTRACT

A bait box (10) has a housing (12) and a lid (14) which can be fitted to the housing (12). The lid (14) can be moved between a locked and closed position and an unlocked and open position. A locking means (34) is provided between the housing (12) and the lid (14) having one or more locking members (40) which can be releasably secured to the housing (12) or the lid (14). The or each locking member (40) and the other of the housing (12) and the lid (14) having interengageable formations (48, 90) which can be used to lock the housing (12) and the lid (14) to each other. The or each locking member (40) can be released from the housing or the lid and can be removed from the housing (12) or the lid (14) when the lid (14) is in the unlocked and open position.

The present invention relates to bait boxes, in particular, although not exclusively rodent bait boxes made from moulded plastics materials.

Existing rodent bait boxes often comprise a housing having a floor and a surrounding wall provided with one or more openings to allow rodents to enter the box, together with a lid. The lid may be hinged to the surrounding wall of the housing or can be fitted and secured to the wall. The housing and lid are usually made from a moulded plastics material.

In both types of known bait box a latch or lock is provided between the housing and the lid to secure them together. The latch or lock normally takes the form of one or more flexible prongs or tangs each having a hook portion which can be secured in a recess in the underside of the lid. The prongs or tangs and the related recesses are integral with the housing and lid respectively, being formed as part of the moulding process.

In certain applications it is require that the bait box be made of a relatively tough material which can withstand heavy objects being dropped onto it or rough treatment to the exterior. However, if existing boxes are made from a material which is relatively tough the prongs or tangs may not be flexible enough to move into engagement with the corresponding recesses when the housing and lid are brought together. This limits the range of materials from which the bait box can be made.

Another drawback which is encountered with toughened plastics materials is that it becomes difficult to create bait boxes in which the lid is hinged to the housing by means of an integral or “live” hinge. The stiffness of such materials prevents the live hinge from working effectively.

This has been partly overcome by use of bait boxes having a two-part construction which use a mechanical hinge. WO 99/03340 discloses such a bait box in which the housing and lid are moulded separately. The lid is provided with a plurality of u-shaped clips which hook around the top of the rear wall of the housing to create a mechanical hinge. In this arrangement, the housing has slightly thicker plastic around the hinge and the lid is “clipped-on” or “snap-fitted” around these thickened portions. This mechanical hinge is designed to be permanently attached and not to be removed.

It is common for pest control operatives to write details of their inspection of the box on the inside of the lid. This information can be viewed at subsequent visits to determine the amounts and types of bait which should be used in that location. Ideally, the operative would simply unlock the lid from the housing and lift it away from the housing thereby enabling them to scrutinise and update the box history without having to crouch down by the box. Although bait-boxes such as the one disclosed in WO 99/03340 overcome the limitation on the range of materials which can be used in construction, the use of a “clip-fit” or “snap-fit” hinge makes the lid quite difficult to remove on a regular basis. Repeated removal of the lid from the housing can also effect the operation of the hinge. Use of strong materials would prevent hinge from being clipped together.

The present invention seeks to address the drawbacks of the existing bait boxes by providing a bait box which can be made from a wider ranger of materials than existing bait boxes, and which has a lid which can be more readily and routinely separated from the housing.

According to the present invention there is provided a bait box comprising:

a housing having a floor and a surrounding wall with one or more openings;

a lid which is securable to the housing, and which is movable between a closed position and open position relative to the housing; and

one or more locking members releasably secured to the housing or the lid to lock the lid to the housing in the closed position, in which the or each locking member is releasable from the housing or the lid and which can be removed from the housing or the lid when the lid is in the open position.

Advantageously, releasably securing the locking member(s) to the housing or the lid allows the or each locking member to be made from a material which can differ from those from which the housing and lid are made.

The or each locking member may be made from the same material to that from which the housing and/or lid is constructed. In preferred embodiments, the or each locking member is made from a different material to that of which the housing and/or lid is constructed. The housing and/or lid may be made from a polymeric material. The polymeric material can include one or more of the following polypropylene, super tough nylon or polycarbonate.

The housing may be made in any convenient shape, for example it may have a surrounding wall which is circular. The surrounding wall may comprise three or more connected side walls. The surrounding wall may have four, five, six, seven or eight connected side walls. Conveniently, the surrounding wall has four connected walls. In preferred embodiments, the floor or the housing is rectilinear in shape. Most preferably, the floor of the housing is rectangular. Preferably, the longer sides of the surrounding wall form front and back walls connected by two opposing side walls. One of the side walls may be provided with an opening to allow rodents to enter the box. Most preferably, each of the side walls has an opening.

Preferably, the housing or the lid is provided with one or more apertures which open into the interior of the bait box, and in which at least part of the or each locking member can be inserted into and secured inside the or each aperture. Providing apertures in the housing or lid allows the or each locking member to inserted or removed when the lid is in the open position. In a preferred embodiment, the or each aperture is provided in the floor of the housing.

Conveniently, the or each locking member further comprises a resilient member which can be brought into and out of engagement with an edge of the or each aperture to releasably secure the or each locking member to the housing or lid. A resilient member provides a simple means of engaging the or each locking member to the housing or lid. Preferably, the locking member comprises a body portion to which the resilient member is connected. Conveniently, the resilient member is provided in or adjacent a lock recess. The resilient member may comprise a flexible clip. The resilient member may be connected integrally to the body portion along a first edge and have a free end. The resilient member may project outwardly away from the first edge towards the free end distal from the free edge. Conveniently, at least a part of the resilient member can be pressed into the lock recess. In preferred embodiments, a second end of the locking member comprises a foot.

Preferably, the or each locking member can be secured to a surrounding wall of the housing or to a surrounding wall of the lid. The or each locking member may be secured to the surrounding wall of the housing or lid by a clip. Most preferably, the interengagable formations provided on the or each locking member comprise at least one hook portion, and in which the interengageable formations on the other of the housing or the lid comprise at least one recess adapted to receive a hook portion.

Preferably, the lid has an upper surface which is the same shape as the floor of the housing. The upper surface of the lid may have a surrounding wall. In a preferred embodiment, the surrounding wall may comprise three or more connected side walls. The surrounding wall may have four, five, six, seven or eight connected side walls. Conveniently, the surrounding wall has four connected walls. In preferred embodiments, the lid is rectilinear in shape. Most preferably, the lid is rectangular. Preferably, the longer sides of the surrounding wall form front and back walls connected by two opposing side walls.

The lid may be integrally connected to the housing. Preferably, the lid is connected to the housing by a living hinge. Most preferably, the lid and housing are separable. Producing a separable housing and lid increases the range of materials that the bait box can be made from.

Conveniently, in which the housing and lid provide between them one or more tongue-and-groove fittings which can be used to hold the lid in a closed position relative to the housing. Use of tongue-and-groove fittings offers a simple means to secure the lid to the housing. Preferably, the tongue-and-groove fittings are defined by one or more projections on the lid and/or housing. Conveniently, the surrounding wall of the housing is provided with a shoulder. Preferably, the shoulder supports the surrounding wall of the lid when the lid is placed on the housing.

In a preferred embodiment, the housing is provided with a first pair of projections located above the shoulder. Preferably, the first pair of projections and shoulder between then define a first pair of grooves. Conveniently, the inner surface of the front wall of the lid has a second pair of projections. Preferably, each of the second pair of projections can be received in one of the first pair of grooves to form a first tongue-and-groove fitting. In a preferred embodiment, the outer surface of the rear wall of the lid is provided with a third pair of projections. Most preferably, the third pair of projections are parallel to one another. Conveniently, the third pair of projections define a second groove between them. Preferably, the inner surface of the rear wall of the housing is provided with a fourth projection. Conveniently, the fourth projection projects into the interior of the housing. More preferably, the fourth projection can be received in the second groove to form a further tongue-and-groove fitting.

In preferred embodiments, the housing or the lid provide between them one or more hinge housings and one or more hinge fittings, the or each hinge fitting being adapted to be received in a corresponding hinge housing. Insertion of the or each hinge fitting into corresponding hinge housing enables the lid to be secured to the housing.

Preferably, the or each locking member and the other of the housing and the lid are provided with interengageable formations which can be used to lock the housing to the lid. Conveniently, the interengagable formations provided on the or each locking member comprise at least one hook portion, and in which the interengageable formations on the other of the housing or the lid comprise at least one recess adapted to receive a hook portion. A hook portion received in a recess provides a simple yet effective locking mechanism. Preferably, the or each locking member comprises two hook portions which are received a corresponding pair of recesses in the lid. Conveniently, the or each recess is provided with a ledge. In preferred embodiments, the or each hook portion has a surface which engages a ledge in the or each recess which locks the lid to the housing.

The or each locking member may be made from a polymeric material. For example the or each locking member may be made from polypropylene, super tough nylon or polycarbonate. Most preferably, the locking member is made from nylon. Preferably, the or each locking member is made of a nylon material. Nylon is a relatively flexible material which allows the resilient member and hook portion of the locking member to be deformed from a resting position as the locking member is inserted or removed into or out an aperture in the housing or as the lid is locked to the housing respectively.

Conveniently, the or each locking member is made from a material which has a lower tensile strength than the material from which the housing and or lid are constructed.

According to a second aspect of the present invention there is provided a bait box comprising:

a housing having a floor and a surrounding wall with one or more openings; and

a lid which can be secured to the housing, and which can be moved between a closed position and open position;

in which the housing and lid provide between them one or more tongue-and-groove fittings which can be used to secure the lid to the housing.

The use of tongue-and-groove fittings enables the lid to be located on the housing and removed from the housing more readily and routinely than if a mechanical hinge were provided.

According to a third aspect of the present invention there is provided a bait box comprising:

a housing having a floor and a surrounding wall with one or more openings; and

a lid which can be secured to the housing, and which can be moved between a closed position and open position;

in which the housing or the lid provide between them one or more hinge housings and one or more hinge fittings, the or each hinge fitting being adapted to be received in a corresponding hinge housing to secure the lid to the housing.

The use of hinge housings and hinge fittings enables the lid to be located on the housing and removed from the housing more readily and routinely than if a mechanical hinge were provided.

The second and third aspects of the present invention can include any of the preferred features relating to the first aspect of the invention as laid out above or any features laid out elsewhere in the description.

Embodiments of the present invention will now be described, by way of example only, with reference to the following figures in which:

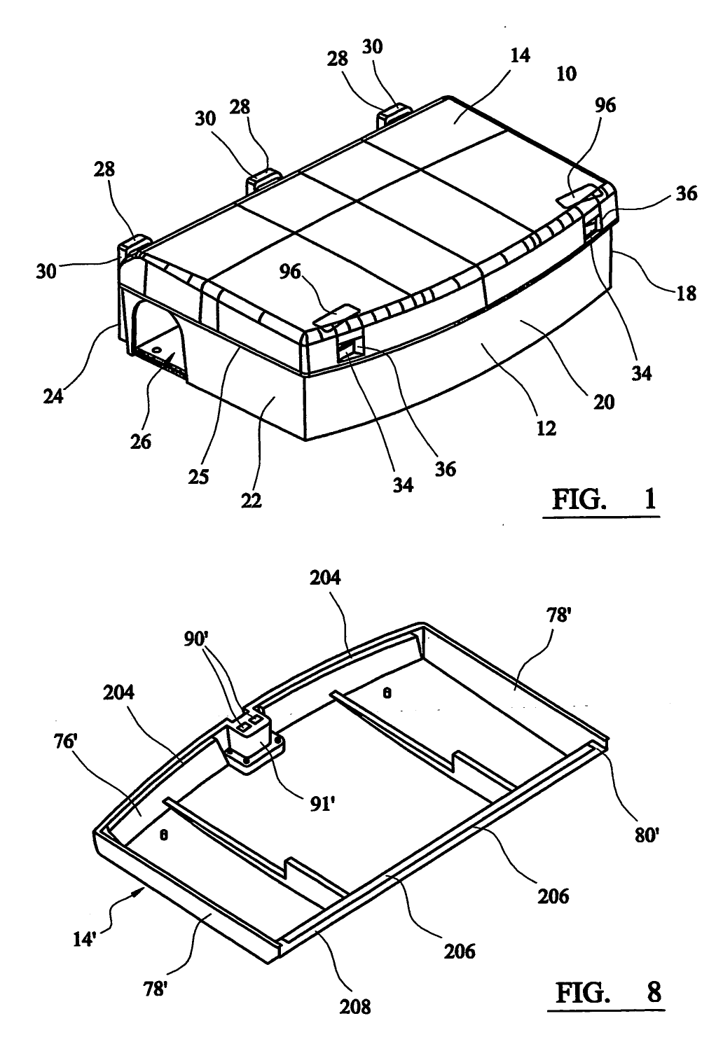

FIG. 1 shows a front perspective view of the exterior of a bait box in accordance with the a first embodiment of the present invention in a closed and locked configuration;

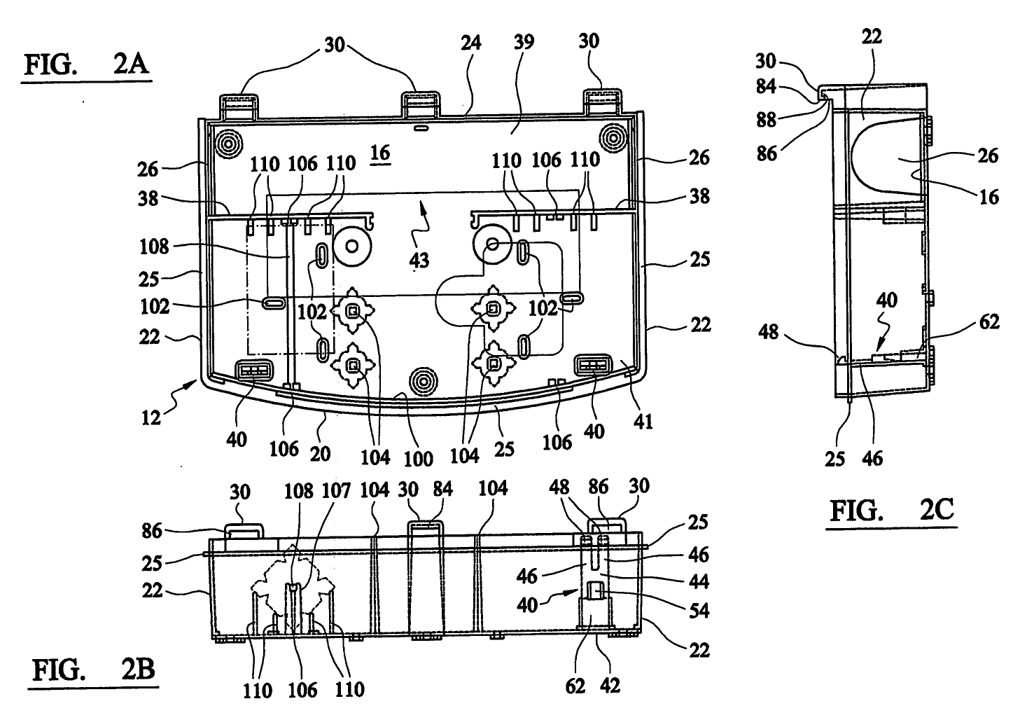

FIG. 2A shows a plan view of a housing of the bait box shown in FIG. 1;

FIG. 2B shows a side-view of the housing shown in FIG. 2A;

FIG. 2C shows a front view of the housing shown in FIG. 2A;

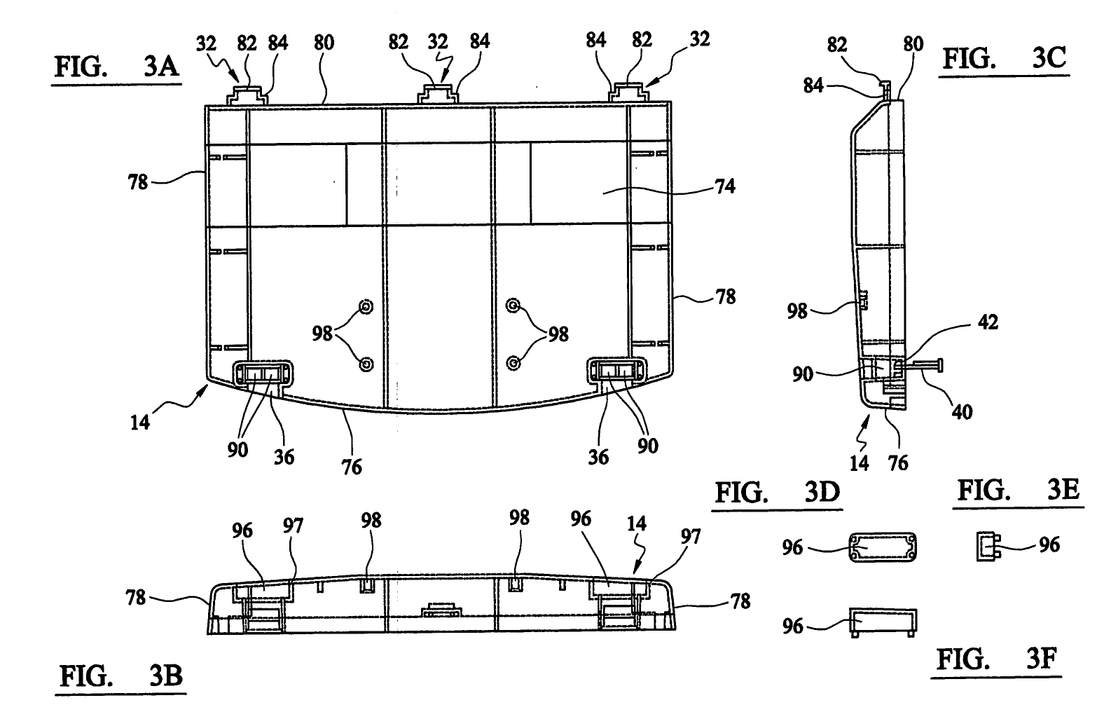

FIG. 3A shows a plan view of a lid of the bait box shown in FIG. 1;

FIG. 3B shows a side view of the lid shown in FIG. 3A;

FIG. 3C shows a front view of the lid shown in FIG. 3A;

FIGS. 3D, 3E and 3F show plan, end elevation and side elevations respectively of a blanking piece for use with the lid in FIGS. 3A, 3B and 3C;

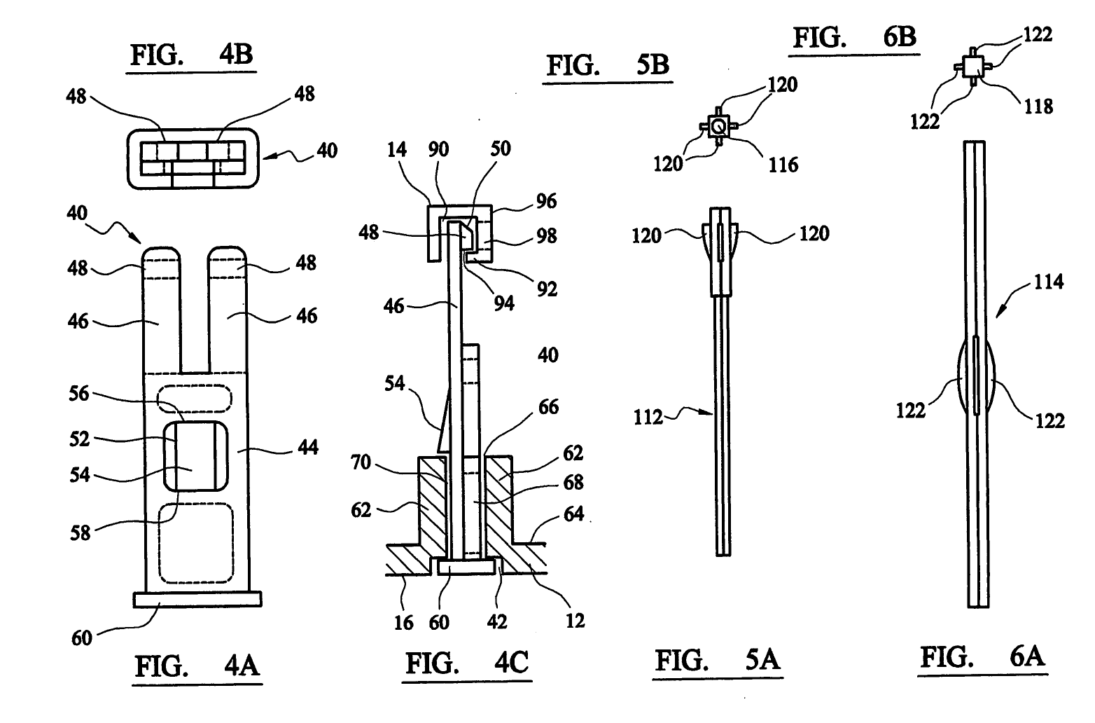

FIGS. 4A, 4B and 4C show front, plan and side views respectively of a locking member in accordance with the present invention;

FIGS. 5A and 5 B show a plan view and a side view of a bait rod;

FIGS. 6A and 6B show a plan view and a side view of a bait rod;

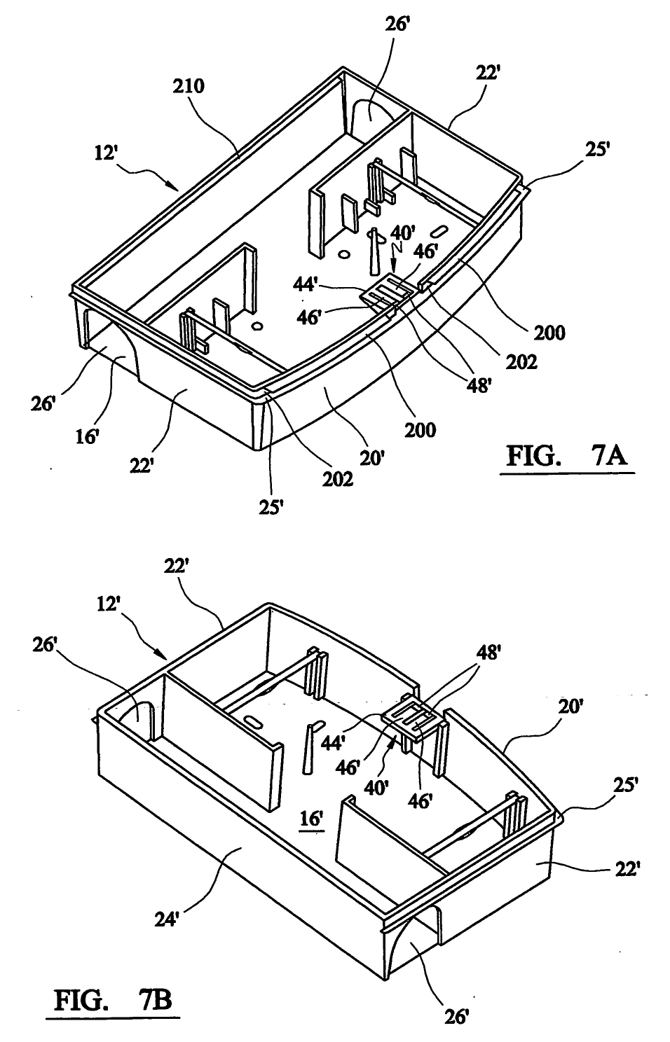

FIGS. 7A and 7B show front and rear perspective views of a housing in accordance with a further embodiment of the present invention;

FIG. 8 shows a perspective view of the underside of a lid in accordance with a second embodiment of the present invention;

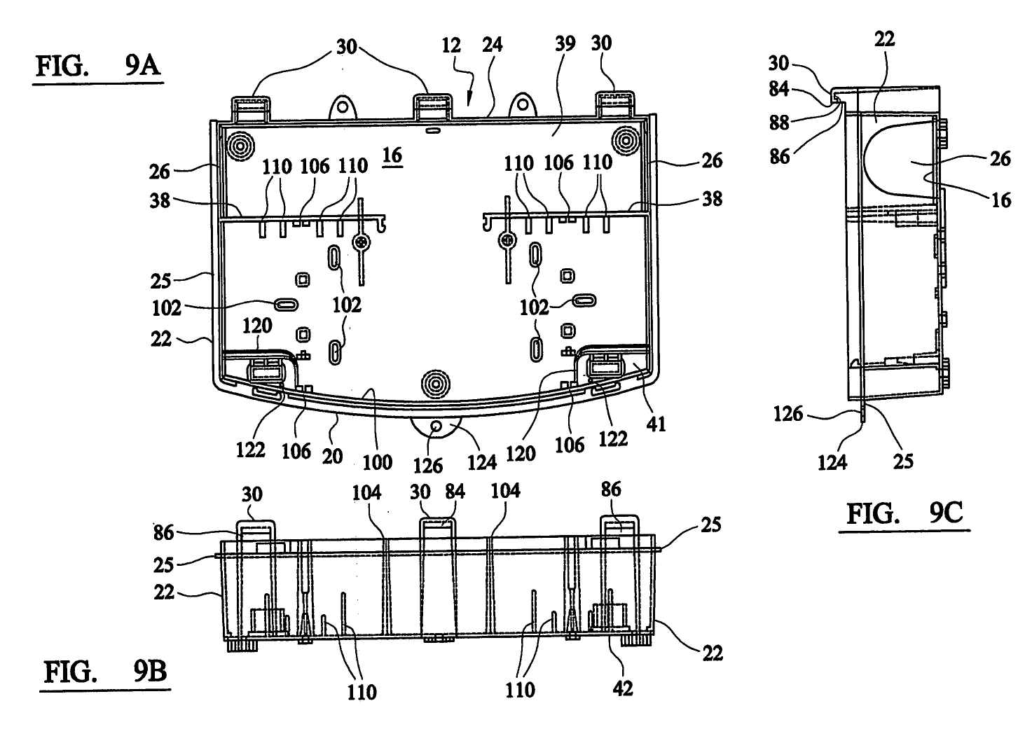

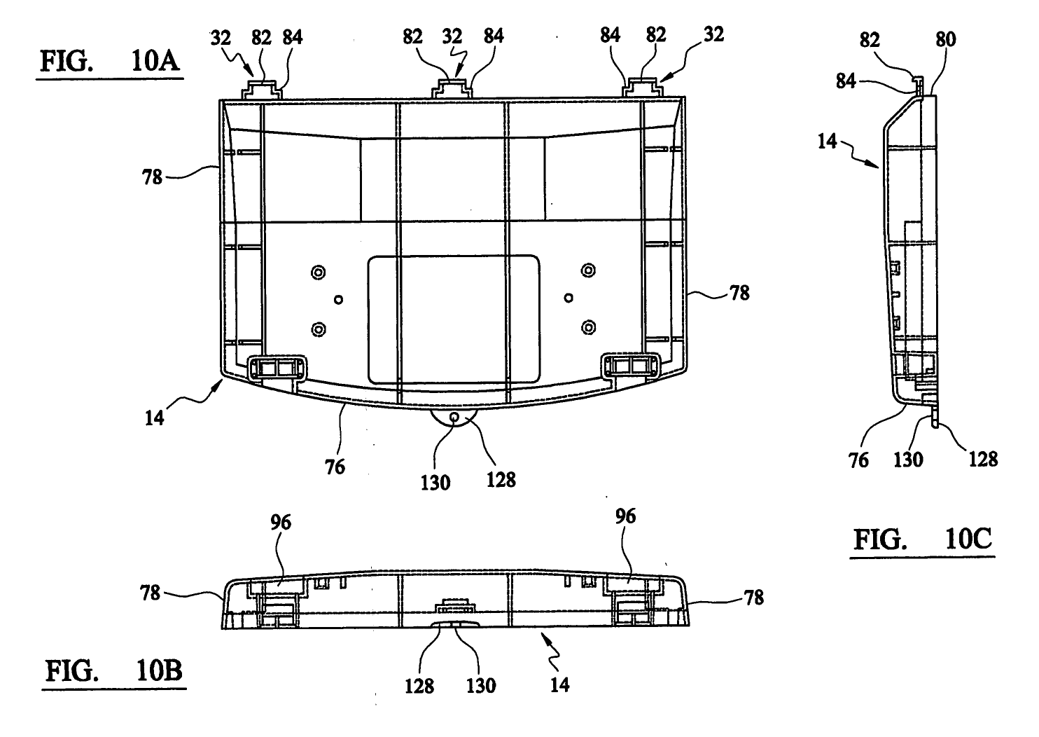

FIGS. 9A, 9B, and 9C show respectively a plan view, a side view, and a front view of the housing shown in FIGS. 2A, 2B, and 2C including a shroud and a first securement means; and

FIGS. 10A, 10B, and 10C show respectively a plan view, a side view, and a front view of the lid shown in FIGS. 3A, 3B, and 3C including a second securement means.

FIG. 1 shows a bait box 10 in accordance with a first embodiment of the present invention. The bait box 10 has a housing 12 and a lid 14 which can be moved between a closed and locked position (as shown in FIG. 1) and an open and unlocked position (not shown). The housing 12 and lid 14 may be formed by moulding. The housing 12 has a floor 16 which is connected to an upstanding surrounding wall 18. The surrounding wall 18 has a front wall 20, two side walls 22 and a rear wall 24. A shoulder 25 is provided towards the top of the side walls 22 and rear wall 24 to support the lid 14 when it is placed on the housing 12. One or more openings 26 are provided in the surrounding wall 18 to allow rodents to enter the box.

In the embodiment shown in FIG. 1, the lid 14 is attached to the housing 12 by three hinges 28 which form a mechanical hinge. Three hinge housings 30 are provided on the rear wall 24 of the housing 12 into which three corresponding hinge fittings 32 on the lid 14 can be located. The lid 14 may be locked to the housing 12 using two locking means 34 (details will follow later), which are accessible through corresponding access holes 36 in the front of the lid. Locking the lid 14 to the housing 12 creates a closed container which rodents can enter. Rodent bait containing anti-coagulants or other rodenticides having been placed inside the box.

The housing 12 is shown in greater detail in FIGS. 2A, 2B and 2C. The interior of the housing 12 has a pair of dividing walls 38 each of which is located adjacent an opening 26 in a side wall 22 of the housing 12 to define an entrance corridor 39 for rodents. The dividing walls 38 also define a bait chamber 41 which can be accessed by rodents through a central hole 43. A pair of locking members 40 which form part of the locking means 34 can be seen in plan view in FIG. 2A and in front and side elevations in FIGS. 2B and 2C respectively. Each locking member 40 can be inserted through one of a pair of apertures 42 in the floor 16 of the housing 12, the apertures 42 being located towards the front of the box.

FIGS. 4A and 4B show a locking member 40 in greater detail separated from the housing 12. FIG. 4C shows a locking member 40 in contact with the housing 12 and locked to the lid 14. Each locking member 40 has an elongate body portion 44 with a first end from which two arms 46 extend. Each of these arms has a hook portion 48 with a sloping surface 50. The body portion 44 of the locking member 40 has a lock recess 52 which is generally rectilinear as viewed in FIG. 4A. A resilient member 54 comprising a flexible clip, is connected integrally to the body portion 44 along a first edge 56 and has a free end 58. The resilient member 54 projects outwardly away from the first edge 56 towards the free end 58 and can be pressed into the lock recess 52. A second end of the locking member 40 takes the form of a foot 60.

In use, a locking member 40 can be pushed into one of the apertures 22 in the floor 16 of the housing 12. A tube 62 is formed on the inner surface 64 of the floor 16 of the housing 12. The tube 62 has a central passage 66 which forms a close fit around a lower portion 68 of the body portion 44 of the locking member 40. The locking member 40 is inserted into the aperture 22 with the hook portions 48 entering first. The hook portions 48 are then pushed through the passage 66 into the tube 62. As the body portion 40 is pushed into the passage 66 there comes a point where the resilient member 54 flexes inwardly as it contacts an inner surface 70 of the tube 62. The resilient member 54 remains pressed into the lock recess 52 until the free end 58 of the resilient member 54 is pushed past an upper edge 72 of the tube 62. The resilient member 54 then flexes outwardly such that the free end 58 projects outwardly into contact with the upper edge 72 of the tube 62 thereby preventing release of the locking member 40 from the tube 62.

To release the locking member 40 from the housing 12, the resilient member 54 is depressed into the lock recess 52 so that the free end 58 no longer contacts the upper edge 72 of the tube 62. The locking member 40 can then be pushed and/or pulled out of the tube 62 for release from the housing 12. The resilient member 54 can only be depressed when the lid 14 has been opened allowing an operative to gain access to the interior of the housing 12. This provides security and prevents accidental release of the locking members 40 from the housing 12.

A lid 14, in accordance with a first embodiment of the present invention, is shown in FIGS. 3A, 3B and 3C. The lid 14 has an upper surface 74, a front wall 76, two side walls 78 and a rear wall 80. The three hinge fittings 32 project from the rear wall 80 of the lid 14 and include a hook 82 which forms part of a hinge arm 84. Each of the hinge housings 30 on the housing 12 have a lip 84 which creates a re-entrant opening 86 into a cavity 88. To connect the lid 14 to the housing 14 the hinge arms 84 are pushed towards the respective cavities 88 in the hinge housings 30. As the hook 82 contacts the lip 84 the hooks 82 are forced downwardly until they become caught behind the lip 84 and are secured in the cavities 88.

The lid 14 is also provided with two pairs of recesses 90 which have a ledge 92. These recesses 90 receive corresponding hook portions 48 on a locking member 40. The recesses 90 take the form of a channel 97 and are formed in the moulding process. The channels are blocked off by blanking pieces 96, shown in FIGS. 3D, 3E and 3F. The blanking pieces are shown in situ in FIGS. 1, 3A, 3B and 3C.

As the lid 14 is placed in position on the housing 12, the ledges 92 slide over the sloping surface 50 of a hook portion 48 and then slip under a lower surface 94 of the hook portion 48 securing it in the recess 90 as illustrated in FIG. 4C. A front recess wall 96 has access holes 98 into which a key (not shown) can be inserted to lever the hook portions 48 out of engagement with the ledges 92. This unlocks the locking mechanism and enables the id 14 to be opened and lifted away from the housing 12.

As seen in FIG. 2A, the floor 16 of the bait chamber 41, the dividing walls 38 and an inner surface 100 of the front wall 20 of the housing 12 have various adaptations which allow bait in a variety of forms to be presented to rodents that enter the bait box 10. Two sets of three studs 102 project upwardly from the floor 16 of the bait chamber 41. Each of these sets of studs 102 can support a drinking tray (not shown) from which rodents can drink water which include an anti-coagulant or a rodenticide. Four spikes 104 oriented vertically project from the floor 16 of the bait chamber 41 upon which blocks of bait can be positioned. The inner surface of the lid 14 is provided with four corresponding spike recesses 98 into which a free end of each spike 104 can be located. This helps to further position the lid 14 on the housing 12 and prevents the spikes 104 from being dislodged by rodents feeding on bait secured to the spikes 104.

Two pairs of supports 106 are provided on opposing surfaces of the dividing walls 38 and the inner surface 100 of the front wall 20 of the housing 12. The supports 106 include a cradle 107 in which a bait rod 108 can be supported. The bait rod 108 can hold a bait block (shown in outline in FIG. 2B) which rodents can feed from. Webs 110 of different sizes are also provided on the dividing wall 38 which prevent rotation of supported bait blocks. Movement of bait discourages rodents, in particular rats, from feeding as it tends to frighten them.

Two further examples of bait rods 112, 114 are illustrated in FIGS. 5A, 5B, 6A and 6B. These further bait rods 112, 114 have a body portion 116, 118 which is square in cross-section and have a plurality of fins which radiate out from the body portion 116, 118. As seen in FIGS. 5A and 5B extended fin portions 120 are provided towards one end of the rod 116. These fin portions 120 cut into the side of bait blocks (not shown) and help to hold the blocks securely to the rod 116. The rod 118 in FIGS. 6A and 6B has extended fin portions 122 located towards the centre of the rod.

In a further embodiment, shown in FIGS. 7A, 7B and 8, the lid 14′ is arranged to be fitted slidingly on the housing 12′. The housing 12′ and lid 14′ are similar on construction to the lid 12 and housing 14 of the embodiment described above. The major differences between this further embodiment and the one described above are the use of a locking member 40′ which clips to the front wall 20′ and the absence of hinges to locate the lid 14′ on the housing 12′.

The front and side walls 20′, 22′ of the housing 12′ are provided with a shoulder 25′ which supports the front and side walls 76′, 78′ of the lid 14′ when the lid 14′ is placed on the housing 12′. The housing 12′ has a first pair of projections 200 located above the shoulder 25′ towards the top of the front wall 20′. Between them the first pair of projections 200 and shoulder 25′ form a first pair of grooves 202. The inner surface of the front wall 76′ of the lid 14′ has a second pair of projections 204 each of which can be received in one of the first pair of grooves 202 to form first tongue-and-groove fittings. Similarly, the outer surface of the rear wall 80′ of the lid 14′ has a third pair of projections 206 which are parallel to one another and form a second groove 208 between them. The inner surface of the rear wall 24′ of the housing 12′ has a fourth projection 210 which projects into the interior of the housing 12′. The fourth projection 210 can be received in the second groove 208 to form a further tongue-and-groove fitting.

In this further embodiment the lid 14′ is slid on to the housing 12′ the two being fitted together using the tongue-and-groove fittings. The lid 14′ can then be locked to the housing 12′. The locking member 40′ in this embodiment is a single piece construction and has a body portion 44′ which supports two arms 46′ each of which has a free end having a hook portion 48′. A pair of recesses 90′ are provided in a block 91′ formed as part of the lid 14′ moulding. Each of the recesses 90′ has a ledge (not shown) which receive corresponding hook portions 48′ on the locking member 40′. As the lid 14′ is placed in position on the housing 12′, the arms 46′ flex downwardly slightly until the ledges engage a hook portion 48′ securing it in a recess 90′. An access hole (not shown) is provided on the front wall 76′ of the lid 14′ into which a key (not shown) can be inserted to lever the hook portions 48′ out of engagement with the ledges. This unlocks the locking mechanism and enables the lid 14′ to be opened and lifted away from the housing 12′.

FIGS. 9A, 9B, 9C show a further embodiment of the housing 12 of the present invention which includes a shroud or wall 120. The shroud 120 is connected to the floor 16, a side wall 22 and the inner surface 100 of the front wall 20. The shroud 120 forms an enclosure around the locking member 40 which is open towards its upper end 121. The shroud 120 acts to collect water which seeps into the box by means of the access holes 36 for the locking means 34. A drain hole 122 is provided in the floor 16 to allow water captured by the enclosure to drain way from the housing 12.

The housing 12 shown in FIGS. 9A and 9C include a first securement means 124 which, in the embodiment shown, is integral with the shoulder 25. The first securement means 124 takes the form of a generally semi-circular member with a circular aperture 126. The lid 14 shown in FIGS. 10A, 10B, and 10C includes a second securement means 128 which, in the embodiment shown, is integral with the front wall 76. The second securement means 128 takes the form of a generally semi-circular member with a circular aperture 130. In use, the lid 14 can be located on the housing 14 such that the first and second securement means 124, 128 are brought in to registration with one another. In this configuration, their respective apertures 126, 130 can be brought into registration with one another. A further locking means (not shown), such as the arm of a padlock, can then be passed through the apertures 126, 130 and used to secure the first and second securement means 124, 128, and hence the lid 14 and housing 12 to each other.

1. A bait box comprising:
a housing having a floor and a surrounding wall with one or more openings;
a lid which is securable to the housing, and which is moveable between a closed position and open position relative to the housing; and
one or more locking members releasably secured to the housing or the lid to lock the lid to the housing in the closed position, in which the or each locking member is releasable from the housing or the lid and which can be removed from the housing or the lid when the lid is in the open position.

2. A bait box as claimed in claim 1, in which the or each locking member is made from a material which is different from that which the housing and/or lid is constructed.

3. A bait box as claimed in claim 1 in which the housing or the lid is provided with one or more apertures which open into the interior of the bait box, and in which at least part of the or each locking member can be inserted into and secured inside the or each aperture.

4. A bait box as claimed in claim 3, in which the or each locking member further comprises a resilient member which can be brought into and out of engagement with an edge of the or each aperture to releasably secure the or each locking member to housing or lid.

5. A bait box as claimed in claim 2, in which the or each locking member can be secured to the surrounding wall of the housing or to a surrounding wall of the lid.

6. A bait box as claimed in claim 1, in which the lid and housing are separable.

7. A bait box as claimed in claim 1, in which the housing and lid provide between them one or more tongue-and-groove fittings which can be used to hold the lid in a closed position relative to the housing.

8. A bait box as claimed in claim 1, in which the housing or the lid provide between them one or more hinge housings and one or more hinge fittings, the or each hinge fitting being adapted to be received in a corresponding hinge housing.

9. A bait box as claimed in claim 1, in which the or each locking member and the other of the housing and the lid are provided with interengageable formations which can be used to lock the housing to the lid.

10. A bait box as claimed in claim 9, in which the interengageable formations provided on the or each locking member comprise at least one hook portion, and in which the interengageable formations on the other of the housing or the lid comprise at least one recess adapted to receive a hook portion.

11. A bait box comprising:
a housing having a floor and a surrounding wall with one or more openings; and
a lid which can be secured to the housing, and which can be moved between a closed position and open position;
in which the housing and lid provide between them one or more tongue-and-groove fittings which can be used to secure the lid to the housing.

12. A bait box comprising:
a housing having a floor and a surrounding wall with one or more openings; and
a lid which can be secured to the housing, and which can be moved between closed position and open position;
in which the housing or the lid provide between them one or more hinge housings and one or more hinge fittings, the or each hinge fitting being adapted to be received in a corresponding hinge housing to secure the lid to the housing.

13. (canceled)
